(19) United States
(12) Patent Application Publication
(10) Pub. No.: US 2002/0075156 A1
(43) Pub. Date: Jun. 20, 2002

(54) Indicating device

(75) Inventor: Wilfried Soker, Hollingstedt (DE)

Correspondence Address: LARSON AND LARSON, 11199 69TH STREET NORTH, LARGO, FL, 33773

(73) Assignee: CLEWARE GmbH

(21) Appl. No.: 10/023,547

(22) Filed: Dec. 18, 2001

(30) Foreign Application Priority Data
Dec. 18, 2000 (DE) DE 200 21 396.2

(51) Int. Cl. G08B 21/00

(52) U.S. Cl. 340/635

(57) ABSTRACT

An indicating device for computers with at least one operating system, an interface for communication by use of a USB or blue-tooth connection, an optically perceptible display apparatus utilizing one or more LED's, and a selector switch for designating a particular operating state or specific communication information is provided. The display apparatus includes an indicating device in the form of a play figure wherein the position of a body part can be moved, i.e. a teddy bear, or an electric motor and rotary parts, i.e. a windmill, or an analog measuring instrument with a needle, i.e. a speedometer and a speedometer needle, or a pump for a water flow, i.e. a room fountain, located in the free upper edge of the monitor of a computer system or an area on the table plate alongside the computer monitor.

### PRIOR APPLICATIONS

This application bases priority on German Application No. DE 200 21 396.2, filed Dec. 18, 2000.

### BACKGROUND OF THE INVENTION

1. Field of Invention

The invention relates to an indicating device for use in a computer system wherein an optically perceptible display apparatus coupled to th computer system indicates a pre-selected operating state of the computer system.

2. Description of the Prior Art

Indicating devices, particularly for computers, are used for controlling the operating state of the system. Indicators also inform users with information as to whether specific connections have been made, and whether data is being transmitted, i.e. the computer system is operating correctly in parallel to other acknowledgments or feedback on the monitor.

Besides communication connections, indicators are also desired which e.g. indicate the utilization of the system enabling the user to know to what extent data is being transmitted at the particular time, or whether as a result of lack of further space on the hard disk, it will be necessary to expect an interruption to the computer program.

Problematic in the display of important information on the monitor of a computer system is that other applications can be superimposed thereon and can completely disappear from the monitor, if there is e.g. an activation of the display protector. If the user requires information on the operating state of the computer, he must either actively deactivate the display protector (which may have to take place several times) or, what is even more complicated, is to always control a display segmentation in such a way that there is always sufficient space for status displays or indications. As the display segmentation is completely taken over by certain software programs, the latter proves particularly difficult. The provision of status lines, such as those, for example, that are present in standard operating systems, is not a ready made solution, because they are generally configured in such a way that they are only activated following a mouse movement on the corresponding display edge.

In addition, some information is only directly displayed on the connected peripherals of a computer monitor. This can be the operational display of a scanner or an external modem, but also e.g. a CAPS-lock display on the keyboard, which must be sought by a user from several positions on the components of the computer system, and which are not provided to him at one location for a faster control of the operating states of the computer system.

The problem of the invention is to offer all the indications or displays required by a user at a single location in a readily accessible manner for the user, so that they can be interrogated and/or recorded without additional activities, and in the best possible case, without additional attention having to be paid to them.

### SUMMARY OF THE INVENTION

According to the invention, this problem is solved by the features of the main claim. The subclaims give advantageous embodiments of the invention.

As the location for the indication can be used at the upper free edge of the monitor, which is available on all standard built-in variants of a computer system, it is also possible to use an area on the table plate alongside the computer monitor. Since, in particular, on the upper edge small playthings or figures are placed on the monitor by many EDP users, it is advantageous to position an indication with an esthetic or playful value at the same location.

For producing a connection between the indicating device and the corresponding computer system components, and having the information to be displayed, it is proposed that the interface is a USB standard connection. This standard makes it possible in a very simple manner and in standardized form to exchange data with peripherals. To a certain extent, the power supply can also take place via the USB connection.

A further special feature of the USB channel is its characteristic of being able to connect equipment when the computer system is running, and which are then identified and integrated with respect to the running time.

As an alternative to a USB interface, it is possible to use a radio link based on the “blue-tooth” standard for the transmission of information. However, the indicating or display device then requires an independent power supply, e.g. batteries or accumulators.

An optically perceptible display apparatus in the indicating device can be displayed either by one or more LED's, by a body part of a play figure, which moves or is displaceable between different positions, or by an electric motor inducing a movement.

For example, the eyes of a play figure can be in the form of LED's, and an electric motor can e.g. drive a windmill in the manner of play figures hitherto offered for solar cells or the legs of a cyclist in the form of a wire figure. It is also possible for painted disks to rotate. Finally, it is possible to deflect analogue measuring instruments, e.g. a speedometer needle, corresponding to the computer operating state to be displayed, e.g. the data transmission rate.

Unlike, in the case of a digital displays, the conversion of speedometer information is easy for human beings, particularly a car driver as a result of widely used analogue clocks and speedometers in motor vehicles, so that he does not have to pay much extra attention, and can instead observe out of the corner of the eye whether or not the needle has taken up its expected position.

In the case where a play figure, such as e.g. a teddy bear is placed on the computer, the existence of a connection or link can e.g. be indicated by the opened eyes. Particularly, when using internal computer modems, it is important, more particularly, for children that they do not have to maintain a modem connection for a long time, but can instead check visually that they have, in fact, “sent the teddy bear to sleep”, i.e. that it no longer has opened eyes. It is also conceivable to visualize or display this by different body postures or actions. Certain postures can also indicate the presence of mail received and which is to be interrogated. It is also conceivable for e.g. an arm with a letter to be raised.

Particularly, in the case of information concerning the operating state of the computer and the possible utilization, it is desirable to visualize by an increasingly rapid movement. For this purpose, it is e.g. possible to use a windmill model, in which the windmill is driven by a small motor, and the latter can make the windmill sails turn more rapidly or slowly in accordance with the displayed data flow rate or utilization. The same effect can be obtained by indication using a painted disk.

Finally, in place of an electric motor, a room fountain pump can also be operated in such a way that simultaneously a desired air humidification effect is obtained, the water flow being controlled in a stronger or weaker manner as a function of computer utilization. Thus, it can be readily indicated to a child that the computer is only in the idle state when the water flow stops.

Such an indication can be evaluated from all directions in space, and also from some distance, so that e.g. it is only necessary for parents to briefly look from the hallway through the door of the children's room to establish whether a modem is on or off. It is desirable for the monitors which have hitherto operated with high voltage that the room fountain should not be placed on the monitor.

### DESCRIPTION OF THE DRAWINGS

Further advantages and features of the invention can be gathered from the following description of a preferred embodiment with reference to the attached drawings, wherein:

FIG. 1 shows an indicating device according to the invention as used with a teddy bear indicator;

FIG. 2 shows an alternate embodiment of the invention as used with a windmill indicator;

FIG. 3 shows an alternate embodiment of the invention as used with a speedometer needle indicator; and

FIG. 4 shows an alternate embodiment of the invention as used with a room fountain indicator.

### DETAILED DESCRIPTION OF THE PREFERRED EMBODIMENT

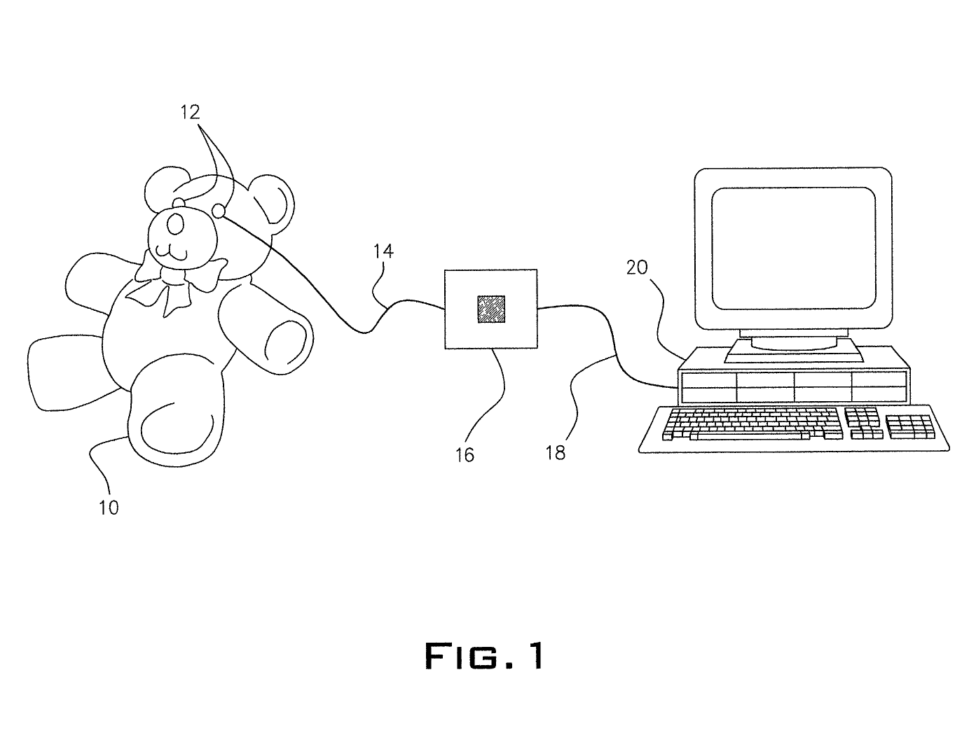

The teddy bear 10 shown in FIG. 1 as an indicating object and as a support for the indicating device, is provided with eyes constructed as LED's 12, which in certain circumstances can have different colors. It is connected by a cable 14 to the USB controller 16, which is in turn connected by a USB cable 18 to a computer 20. The USB controller 16 provides digital information by the switching on or off of differently colored LED's, but optionally also by the opening of sleeping eyes or changing the arm position of the indicating object.

By the blinking of an LED, it is possible to give information on a utilization state, in that e.g. the controller 16 makes one LED blink faster if the computer system is highly utilized. In the same way, the presence of an incoming E-mail can be displayed by the slow blinking or twinkling of the eyes and the presence of a plurality of mails by very rapid blinking or twinkling thereof.

Alternatively, to such an optically perceptible indicating device use can be made of motor indications or displays, where the information to be displayed is converted into mechanical, lasting movements.

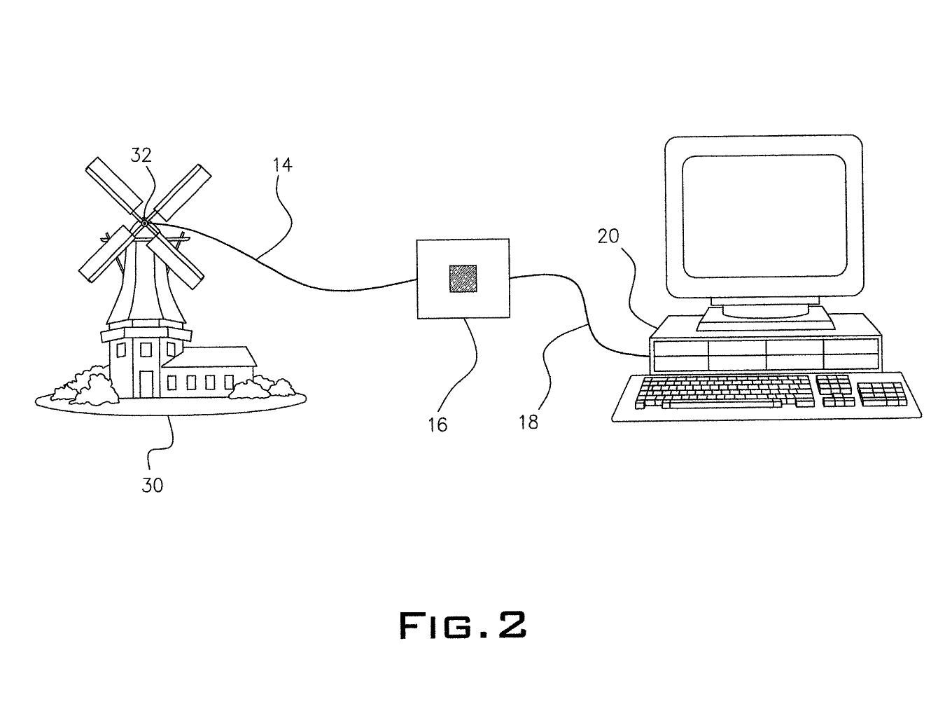

For this purpose, FIG. 2 shows a windmill model with which a windmill 30 is connected by a simple cable 14 to a USB controller 16, which is connected by a cable 18 to the computer 20. A motor 32 is integrated into the model in order to make the windmill sails turn in the presence of an operating state, and this takes place more rapidly or slowly as a function of utilization.

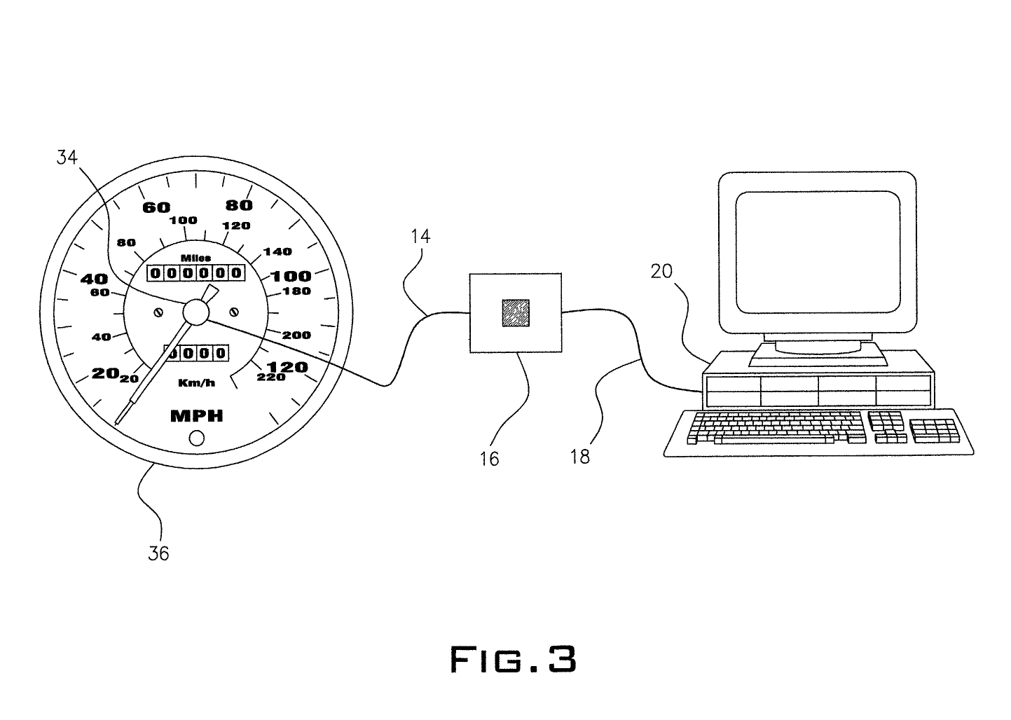

FIG. 3 shows indication by use of a speedometer needle 34, which is well known to people. A speedometer 36 either swinging the needle 34 between different discreet regions or information on the unit to be measured is placed on a speedometer disk or dial, e.g. the number of kilobits per second to be transmitted by a modem connection. The swinging of the speedometer needle 34 makes very clear the presently possible transmission rate. Should this drop to zero, then the modem connection is overloaded and no further data is transmitted, so that the user can equally well interrupt the modem connection.

Currents of different strength are transmitted by use of the cable 14 to the USB controller 16, and the needle 34 is brought into different deflection states by the same. In place of the USB connection 18 to the computer 20 shown in FIG. 3, there can also be a blue-tooth radio link.

In place of a separate power supply, it is possible to provide an indicating device, such as the speedometer 36, with batteries or accumulators, which only have to be recharged every so often. This would e.g. make it possible to make no further software changes in a computer system provided in standard manner with a blue-tooth transmitter, and instead, merely to offer separate indicating devices which can incorporate a plurality of such speedometer disks for different information.

Such devices could be carried by service engineers who can couple them to different computer systems via the radio link, and which indicate to said engineer the necessary information without him having to in any way influence the instantaneous program flow, provided that the corresponding program flows have already outputted the operating state information. The expenditure and effort is certainly less than that of starting special diagnostic programs.

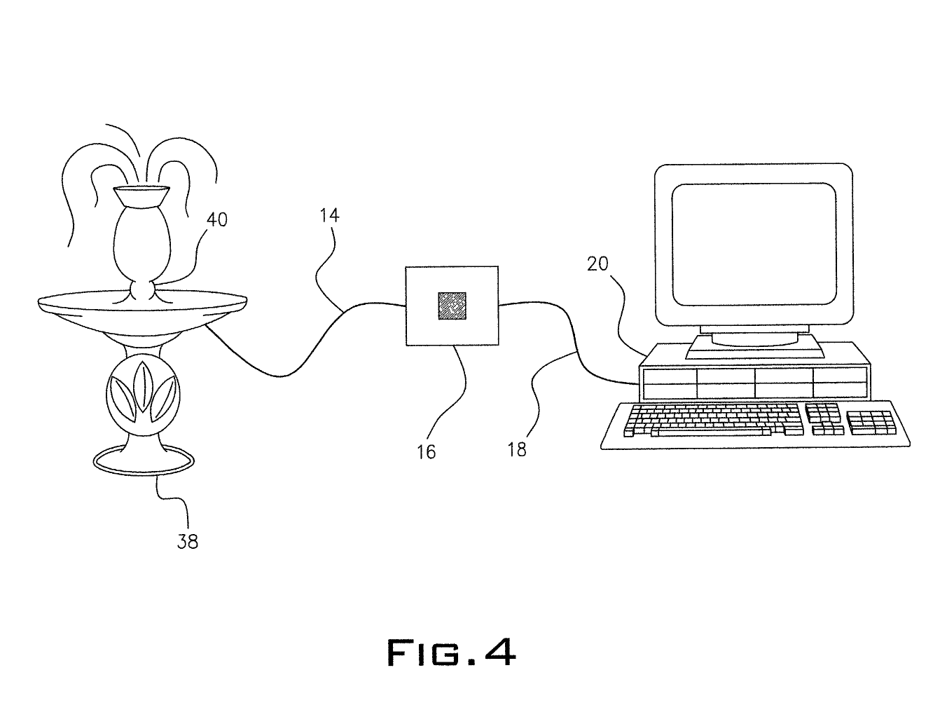

Finally, in FIG. 4, an alternative indicating device is offered using a fountain 38 into which is integrated a water pump 40, which in addition to the optically perceptible height of the vertical water jet, which can also be perceived in a very calming manner without requiring great attentiveness on the part of the computer user and which is accompanied by a further calming effect by water noise. As in the embodiment of FIG. 2, the indicated information can be readily seen from all solid angles, and it is not necessary to move in the display area of a monitor in order to be able to study certain information.

It is also naturally possible to use on the indicating device, digits for indicating specific states, e.g. one or a row of seven-segment displays, and a selector switch can be provided in the indicating device permitting the setting of one of many possible state displays or indications.

The separate indicating device provided by the invention can indicate random operating states of the computer, and there is no longer a need for the effort necessary for “seeking together” indications dispersed over several components, and which only relate to the specific component.

Having thus described the invention, what is claimed and desired to be secured by Letters Patent is:

11. An indication device for communicating at least one operating state of at least one mechanism of a computer system, the indication device comprising:
a) at least one interface for permitting the indication device to communicate with the computer system,
b) a first connection medium for coupling the at least one interface to the computer system,
c) a housing enclosing an optically perceptible display means for displaying a preselected operating state of the computer system, and
d) a second connection medium for coupling the housing to the at least one interface.

12. The indicating device of claim 11, wherein the at least one operating state of the at least one mechanism of the computer system is a modem connection.

13. The indicating device according to claim 11, wherein the optically perceptible display means comprises at least one LED.

14. The indicating device according to claim 11, wherein the at least one interface is a USB connector.

15. The indicating device according to claim 11, wherein the first and second connection mediums are chosen from the group consisting of cables and wireless transmitters.

16. The indicating device according to claim 11, wherein the housing is a simulated play toy.

17. The indicating device according to claim 16, wherein the simulated play toy is chosen from the group consisting of a stuffed animal, a model toy, a numerical stenciled dial and a liquid dispensing fountain.

18. The indicating device according to claim 16, wherein a portion of the simulated play toy includes at least one moveable body part.

19. The indicating device according to claim 18, wherein the moveable body part is operated by a motor.

20. The indicating device according to claim 17, wherein the liquid dispensing fountain includes pump.

21. The indicating device according to claim 17, wherein the numerical stenciled dial includes an analog measuring instrument with a needle.

22. The indicating device according to claim 17, wherein the numerical stenciled dial includes a row with several seven-segment displays.

23. The indicating device according to claim 11, further comprising a display selector switch.

24. The indicating device according to claim 23, wherein the selector switch displays a particular operating state of the computer system.

25. The indicating device according to claim 23, wherein the selector switch displays specific communication information relating to an Internet or LAN connection.
